(19) United States
(12) Patent Application Publication
(10) Pub. No.: US 2020/0180258 A1
(43) Pub. Date: Jun. 11, 2020

(54) Multi-Layer, Flexible Tubular Article for Fuel Line Applications

(71) Applicant: Lubrizol Advanced Materials, Inc., Cleveland, OH (US)

(72) Inventor: Chetan M. Makadia, Strongsville, OH (US)

(73) Assignee: Lubrizol Advanced Materials, Inc., Cleveland, OH (US)

(21) Appl. No.: 16/640,203

(22) PCT Filed: Aug. 22, 2018
(86) PCT No.: PCT/US2018/047412

§ 371 Date: Feb. 19, 2020

Related U.S. Application Data
(60) Provisional application No. 62/550,044, filed on Aug. 25, 2017.

(51) Int. Cl. B32B 1/08; B32B 27/08; F16L 11/04

(52) U.S. Cl. CPC B32B 1/08; B32B 27/306; F16L 11/04; B32B 27/08

(57) ABSTRACT

The invention provides a multi-layer, flexible tubular article useful in fuel line applications comprising a thermoplastic polyurethane layer (10,14,18), an ethylene vinyl alcohol layer (16), and, optionally, a polyamide polymer layer (12,20) to provide an effective barrier against fuel permeation and to reduce washout of chemicals from the tube into the fuel.

### FIELD OF THE INVENTION

The present invention relates to multi-layer tubing and compositions for making such multi-layer tubing.

### BACKGROUND OF THE INVENTION

Multi-layer or laminated rubber tubing is often used for fuel transport in automotive fuel feed lines and similar devices. One issue with such fuel tubes is that some hydrocarbon fuels can act as a solvent that leach chemical compounds from the fuel tubes. In addition, in order to meet increasingly stringent emissions requirements, multi-layered fuel tubes are becoming standard, and new materials are being added to the fuel tubes to provide better barriers to protect against the release of hydrocarbons into the environment. Some of these new materials include fluoropolymers, however, in some cases, fluoropolymers have been associated with environmental concerns. Another issue with these improved barrier materials is that often they are very stiff and cannot provide the requisite flexibility for all applications. Therefore, it is desired to provide a flexible fuel tube that limits the washout of chemicals from the tube into the fuel as well as providing an appropriate barrier against hydrocarbon emissions. In addition, it would be beneficial to have a flexible fuel tube that is free of fluoropolymers.

### SUMMARY

In one embodiment, the present invention provides a multi-layer, flexible tubular article useful for transporting volatile hydrocarbon fuels comprising (a) a thermoplastic polyurethane layer, (b) an ethylene vinyl alcohol layer, and, optionally, (c) a polyamide polymer layer. In another embodiment, the present invention provides a multi-layer, flexible tubular article useful for transporting volatile hydrocarbon fuels comprising (a) a thermoplastic polyurethane layer, (b) an ethylene vinyl alcohol layer, and (c) a polyamide polymer layer.

The thermoplastic polyurethane composition used for the thermoplastic polyurethane layer comprises the reaction product of a polyisocyanate, a polyol intermediate component, and, optionally, a chain extender component. The polyol intermediate component may be selected from polyesters, polyethers, polycaprolactones and other known polyol intermediates. In one embodiment of the invention, the thermoplastic polyurethane composition comprises 25% by weight or more of the polyol intermediate component and has a flex modulus as measured by ASTM D790 of 50,000 psi or less.

### DETAILED DESCRIPTION

The present invention provides a multi-layer, flexible tubular article useful for transporting volatile hydrocarbon fuels comprising (a) a thermoplastic polyurethane layer, (b) an ethylene vinyl alcohol layer, and optionally, (c) a polyamide polymer layer. In some embodiments, the polyamide polymer layer is required and not optional. The layers of the multi-layer, flexible tubular article are co-extruded or extruded one layer over the other without the need for additional adhesive layers (also referred to as “tie layers”) between the layers of the tube. Each of the compositions used to make the layers of the present invention are generally known, but additional features about each composition are described in more detail below.

### Thermoplastic Polyurethanes

Thermoplastic polyurethanes are generally the reaction product of a polyisocyanate component, a polyol intermediate component, and optionally a chain extender component.

Any polyisocyanates known to those skilled in the art may be used to make TPU compositions useful in the present invention. In some embodiments, the polyisocyanate component includes one or more diisocyanates, which may be selected from aromatic diisocynates or aliphatic diisocyanates or combinations thereof. Examples of useful polyisocyanates include, but are not limited to aromatic diisocyanates such as 4,4′-methylenebis(phenyl isocyanate) (MDI), m-xylene diisocyanate (XDI), phenylene-1,4-diisocyanate, 3,3′-dimethyl-4,4′-biphenylene diisocyanate (TODI), 1,5-naphthalene diisocyanate (NDI), and toluene diisocyanate (TDI), as well as aliphatic diisocyanates such as isophorone diisocyanate (IPDI), 1,6-hexamethylene diisocyanate (HDI), 1,4-cyclohexyl diisocyanate (CHDI), decane-1,10-diisocyanate, lysine diisocyanate (LDI), 1,4-butane diisocyanate (BDI), pentamethylene diisocyanate (PDI), and dicyclohexylmethane-4,4′-diisocyanate (H12MDI). Mixtures of two or more polyisocyanates may be used.

Isocyanates used to make the TPU compositions useful in the present invention will depend on the desired properties of the final composite laminate structure as will be appreciated by those skilled in the art.

The TPU compositions useful in the present invention are also made using a polyol intermediate component. Polyol intermediates include polyether polyols, polyester polyols, polycarbonate polyols, polysiloxane polyols, and combinations thereof.

Suitable hydroxyl terminated polyester intermediates include linear polyesters having a number average molecular weight (Mn) of from about 300 to about 10,000, from about 400 to about 5,000, or from about 500 to about 4,000. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycols described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

In some embodiments, dimer fatty acids may be used to prepare polyester polyols that may be used in making the TPU compositions useful in the present invention. Examples of dimer fatty acids that may be used to prepare polyester polyols include Priplast™ polyester glycols/polyols commercially available from Croda and Radia® polyester glycols commercially available from Oleon.

The polyol component of the TPU compositions may also comprise one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from ε-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers.

Useful examples include CAPA™ 2202A, a 2,000 number average molecular weight (Mn) linear polyester diol, and CAPA™ 2302A, a 3,000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 300 to 10,000, or from 400 to 5,000, or from 400 to 4,000, or even 1,000 to 4,000.

Hydroxyl terminated polyether intermediates useful in making TPU compositions of the present invention include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Commercially available polyether polyols include poly(ethylene glycol) comprising ethylene oxide reacted with ethylene glycol, poly(propylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as PolyTHF® B, a block copolymer, and PolyTHF® R, a random copolymer. The various polyether intermediates generally have a number average molecular weight (Mn) as determined by assay of the terminal functional groups which is an average molecular weight greater than about 500, such as from about 500 to about 10,000, from about 500 to about 5,000, or from about 700 to about 3000. In some embodiments, the polyether intermediate includes a blend of two or more different molecular weight polyethers, such as a blend of 2,000 Mn and 1,000 Mn PTMEG.

Hydroxyl terminated polycarbonates useful in preparing TPU compositions of the present invention include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

In some embodiments, the polyol intermediate may also comprise telechelic polyamide polyols. Suitable polyamide oligomers, including telechelic polyamide polyols, are not overly limited and include low molecular weight polyamide oligomers and telechelic polyamides (including copolymers) that include N-alkylated amide groups in the backbone structure. Telechelic polymers are macromolecules that contain two reactive end groups. Amine terminated polyamide oligomers can be useful as polyols in the disclosed technology. The term polyamide oligomer refers to an oligomer with two or more amide linkages, or sometimes the amount of amide linkages will be specified. A subset of polyamide oligomers are telechelic polyamides. Telechelic polyamides are polyamide oligomers with high percentages, or specified percentages, of two functional groups of a single chemical type, e.g. two terminal amine groups (meaning either primary, secondary, or mixtures), two terminal carboxyl groups, two terminal hydroxyl groups (again meaning primary, secondary, or mixtures), or two terminal isocyanate groups (meaning aliphatic, aromatic, or mixtures). Ranges for the percent difunctional that can meet the definition of telechelic include at least 70, 80, 90 or 95 mole % of the oligomers being difunctional as opposed to higher or lower functionality. Reactive amine terminated telechelic polyamides are telechelic polyamide oligomers where the terminal groups are both amine types, either primary or secondary and mixtures thereof, i.e. excluding tertiary amine groups.

In one embodiment, the telechelic oligomer or telechelic polyamide will have a viscosity measured by a Brookfield circular disc viscometer with the circular disc spinning at 5 rpm of less than 100,000 cps at a temperature of 70° C., less than 15,000 or 10,000 cps at 70° C., less than 100,000 cps at 60 or 50° C., less than 15,000 or 10,000 cps at 60° C.; or less that 15,000 or 10,000 cps at 50° C. These viscosities are those of neat telechelic prepolymers or polyamide oligomers without solvent or plasticizers. In some embodiments, the telechelic polyamide can be diluted with solvent to achieve viscosities in these ranges.

In some embodiments, the polyamide oligomer is a species below 20,000 g/mole molecular weight, e.g. often below 10,000; 5,000; 2,500; or 2,000 g/mole, that has two or more amide linkages per oligomer. The telechelic polyamide has molecular weight preferences identical to the polyamide oligomer. Multiple polyamide oligomers or telechelic polyamides can be linked with condensation reactions to form polymers, generally above 100,000 g/mole.

Generally amide linkages are formed from the reaction of a carboxylic acid group with an amine group or the ring opening polymerization of a lactam, e.g. where an amide linkage in a ring structure is converted to an amide linkage in a polymer. In one embodiment a large portion of the amine groups of the monomers are secondary amine groups or the nitrogen of the lactam is a tertiary amide group. Secondary amine groups form tertiary amide groups when the amine group reacts with carboxylic acid to form an amide. For the purposes of this disclosure the carbonyl group of an amide, e.g. as in a lactam, will be considered as derived from a carboxylic acid group. The amide linkage of a lactam is formed from the reaction of carboxylic group of an aminocarboxylic acid with the amine group of the same aminocarboxylic acid. In one embodiment, we want less than 20, 10 or 5 mole percent of the monomers used in making the polyamide to have functionality in polymerization of amide linkages of 3 or more.

The polyamide oligomers and telechelic polyamides of this disclosure can contain small amounts of ester linkages, ether linkages, urethane linkages, urea linkages, etc. if the additional monomers used to form these linkages are useful to the intended use of the polymers.

As earlier indicated, many amide forming monomers create on average one amide linkage per repeat unit. These include diacids and diamines when reacted with each other, aminocarboxylic acids, and lactams. These monomers, when reacted with other monomers in the same group, also create amide linkages at both ends of the repeat units formed. Thus we will use both percentages of amide linkages and mole percent and weight percentages of repeat units from amide forming monomers. Amide forming monomers will be used to refer to monomers that form on average one amide linkage per repeat unit in normal amide forming condensation linking reactions.

In one embodiment, at least 10 mole percent, or at least 25, 45 or 50, and or even at least 60, 70, 80, 90, or 95 mole % of the total number of the heteroatom containing linkages connecting hydrocarbon type linkages are characterized as being amide linkages. Heteroatom linkages are linkages such as amide, ester, urethane, urea, ether linkages where a heteroatom connects two portions of an oligomer or polymer that are generally characterized as hydrocarbons (or having carbon to carbon bonds, such as hydrocarbon linkages). As the amount of amide linkages in the polyamide increases, the amount of repeat units from amide forming monomers in the polyamide increases. In one embodiment, at least 25 wt. %, or at least 30, 40, 50, or even at least 60, 70, 80, 90, or 95 wt. % of the polyamide oligomer or telechelic polyamide is repeat units from amide forming monomers, also identified as monomers that form amide linkages at both ends of the repeat unit. Such monomers include lactams, aminocarboxylic acids, dicarboxylic acid and diamines. In one embodiment, at least 50, 65, 75, 76, 80, 90, or 95 mole percent of the amide linkages in the polyamide oligomer or telechelic polyamine are tertiary amide linkages.

The percent of tertiary amide linkages of the total number of amide linkages was calculated with the following equation:

$$Tertiary amide linkage \% = \frac{{\sum }_{i = 1}^{n} ( {w}_{tertN , i} \times {n}_{i} )}{{\sum }_{i = 1}^{n} ( {w}_{totalN , i} \times {n}_{i} )} \times 100$$

where: n is the number of monomers; the index i refers to a certain monomer; w_{tertN} is the average number nitrogen atoms in a monomer that form or are part of tertiary amide linkages in the polymerizations, (note: end-group forming amines do not form amide groups during the polymerizations and their amounts are excluded from w_{tertN}); w_{totalN} is the average number nitrogen atoms in a monomer that form or are part of tertiary amide linkages in the polymerizations (note: the end-group forming amines do not form amide groups during the polymerizations and their amounts are excluded from w_{totalN}); and n, is the number of moles of the monomer with the index i.

The percent of amide linkages of the total number of all heteroatom containing linkages (connecting hydrocarbon linkages) was calculated by the following equation:

$$Amide linkage \% = \frac{{\sum }_{i = 1}^{n} ( {w}_{totalN , i} \times {n}_{i} )}{{\sum }_{i = 1}^{n} ( {w}_{totalS , i} \times {n}_{i} )} \times 100$$

where: w_{totalS} is the sum of the average number of heteroatom containing linkages (connecting hydrocarbon linkages) in a monomer and the number of heteroatom containing linkages (connecting hydrocarbon linkages) forming from that monomer by the reaction with a carboxylic acid bearing monomer during the polyamide polymerizations; and all other variables are as defined above. The term “hydrocarbon linkages” as used herein are just the hydrocarbon portion of each repeat unit formed from continuous carbon to carbon bonds (i.e. without heteroatoms such as nitrogen or oxygen) in a repeat unit. This hydrocarbon portion would be the ethylene or propylene portion of ethylene oxide or propylene oxide; the undecyl group of dodecyllactam, the ethylene group of ethylenediamine, and the (CH₂)₄ (or butylene) group of adipic acid.

In some embodiments, the amide or tertiary amide forming monomers include dicarboxylic acids, diamines, aminocarboxylic acids and lactams. Suitable dicarboxylic acids are where the alkylene portion of the dicarboxylic acid is a cyclic, linear, or branched (optionally including aromatic groups) alkylene of 2 to 36 carbon atoms, optionally including up to 1 heteroatom per 3 or 10 carbon atoms of the diacid, more preferably from 4 to 36 carbon atoms (the diacid would include 2 more carbon atoms than the alkylene portion). These include dimer fatty acids, hydrogenated dimer acid, sebacic acid, etc.

Suitable diamines include those with up to 60 carbon atoms, optionally including one heteroatom (besides the two nitrogen atoms) for each 3 or 10 carbon atoms of the diamine and optionally including a variety of cyclic, aromatic or heterocyclic groups providing that one or both of the amine groups are secondary amines.

Such diamines include Ethacure™ 90 from Albermarle (supposedly a N,N′-bis(1,2,2-trimethylpropyl)-1,6-hexanediamine); Clearlink™ 1000 from Dorf Ketal, or Jefflink™ 754 from Huntsman; N-methylaminoethanol; dihydroxy terminated, hydroxyl and amine terminated or diamine terminated poly(alkyleneoxide) where the alkylene has from 2 to 4 carbon atoms and having molecular weights from about 40 or 100 to 2,000; N,N′-diisopropyl-1,6-hexanediamine; N,N′-di(sec-butyl) phenylenediamine; piperazine; homopiperazine; and methyl-piperazine.

Suitable lactams include straight chain or branched alkylene segments therein of 4 to 12 carbon atoms such that the ring structure without substituents on the nitrogen of the lactam has 5 to 13 carbon atoms total (when one includes the carbonyl) and the substituent on the nitrogen of the lactam (if the lactam is a tertiary amide) is an alkyl group of from 1 to 8 carbon atoms and more desirably an alkyl group of 1 to 4 carbon atoms. Dodecyl lactam, alkyl substituted dodecyl lactam, caprolactam, alkyl substituted caprolactam, and other lactams with larger alkylene groups are preferred lactams as they provide repeat units with lower Tg values. Aminocarboxylic acids have the same number of carbon atoms as the lactams. In some embodiments, the number of carbon atoms in the linear or branched alkylene group between the amine and carboxylic acid group of the aminocarboxylic acid is from 4 to 12 and the substituent on the nitrogen of the amine group (if it is a secondary amine group) is an alkyl group with from 1 to 8 carbon atoms, or from 1 or 2 to 4 carbon atoms.

In one embodiment, desirably at least 50 wt. %, or at least 60, 70, 80 or 90 wt. % of said polyamide oligomer or telechelic polyamide comprise repeat units from diacids and diamines of the structure of the repeat unit being:

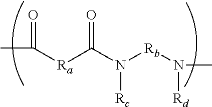

wherein: Rₐ is the alkylene portion of the dicarboxylic acid and is a cyclic, linear, or branched (optionally including aromatic groups) alkylene of 2 to 36 carbon atoms, optionally including up to 1 heteroatom per 3 or 10 carbon atoms of the diacid, more preferably from 4 to 36 carbon atoms (the diacid would include 2 more carbon atoms than the alkylene portion); and R_{b} is a direct bond or a linear or branched (optionally being or including cyclic, heterocyclic, or aromatic portion(s)) alkylene group (optionally containing up to 1 or 3 heteroatoms per 10 carbon atoms) of 2 to 36 or 60 carbon atoms and more preferably 2 or 4 to 12 carbon atoms and R_{c} and R_{d} are individually a linear or branched alkyl group of 1 to 8 carbon atoms, more preferably 1 or 2 to 4 carbon atoms or R_{c} and R_{d} connect together to form a single linear or branched alkylene group of 1 to 8 carbon atoms or optionally with one of R_{c} and R_{d} is connected to R_{b} at a carbon atom, more desirably R_{c} and R_{d} being an alkyl group of 1 or 2 to 4 carbon atoms.

In one embodiment, desirably at least 50 wt. %, or at least 60, 70, 80 or 90 wt. % of said polyamide oligomer or telechelic polyamide comprise repeat units from lactams or amino carboxylic acids of the structure:

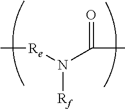

Repeat units can be in a variety of orientations in the oligomer derived from lactams or amino carboxylic acid depending on initiator type, wherein each Rₑ independently is linear or branched alkylene of 4 to 12 carbon atoms and each R_{f} independently is a linear or branched alkyl of 1 to 8, more desirably 1 or 2 to 4, carbon atoms.

In some embodiments, the telechelic polyamide polyols include those having (i) repeat units derived from polymerizing monomers connected by linkages between the repeat units and functional end groups selected from carboxyl or primary or secondary amine, wherein at least 70 mole percent of telechelic polyamide have exactly two functional end groups of the same functional type selected from the group consisting of amino or carboxylic end groups; (ii) a polyamide segment comprising at least two amide linkages characterized as being derived from reacting an amine with a carboxyl group, and said polyamide segment comprising repeat units derived from polymerizing two or more of monomers selected from lactams, aminocarboxylic acids, dicarboxylic acids, and diamines; (iii) wherein at least 10 percent of the total number of the heteroatom containing linkages connecting hydrocarbon type linkages are characterized as being amide linkages; and (iv) wherein at least 25 percent of the amide linkages are characterized as being tertiary amide linkages.

The TPU compositions useful in the present invention may, optionally, be made using a chain extender component. Chain extenders include diols, diamines, and combinations thereof.

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, dodecanediol, 1,4-cyclohexanedimethanol (CHDM), 2,2-bis[4-(2-hydroxyethoxy) phenyl]propane (HEPP), hexamethylenediol, heptanediol, nonanediol, dodecanediol, 3-methyl-1,5-pentanediol, ethylenediamine, butanediamine, hexamethylenediamine, and hydroxyethyl resorcinol (HER), and the like, as well as mixtures thereof. In some embodiments the chain extender includes BDO, HDO, 3-methyl-1,5-pentanediol, or a combination thereof. In some embodiments, the chain extender includes BDO. Other glycols, such as aromatic glycols could be used, but in some embodiments the TPUs described herein are essentially free of or even completely free of such materials.

To prepare TPU compositions useful in the present invention, the three reactants (the polyol intermediate, the diisocyanate, and the chain extender) may be reacted together. Any known processes to react the three reactants may be used to make the TPU. In one embodiment, the process is a so-called “one-shot” process where all three reactants are added to an extruder reactor and reacted. The equivalent weight amount of the diisocyanate to the total equivalent weight amount of the hydroxyl containing components, that is, the polyol intermediate and the chain extender glycol, can be from about 0.95 to about 1.10, or from about 0.96 to about 1.02, and even from about 0.97 to about 1.005. Reaction temperatures utilizing a urethane catalyst can be from about 175 to about 245° C., and in another embodiment from 180 to 220° C.

In another embodiment, the TPU can also be prepared utilizing a pre-polymer process. In the pre-polymer route, the polyol intermediates are reacted with generally an equivalent excess of one or more diisocyanates to form a pre-polymer solution having free or unreacted diisocyanate therein. The reaction is generally carried out at temperatures of from about 80 to about 220° C., or from about 150 to about 200° C. in the presence of a suitable urethane catalyst. Subsequently, a chain extender, as noted above, is added in an equivalent amount generally equal to the isocyanate end groups as well as to any free or unreacted diisocyanate compounds. The overall equivalent ratio of the total diisocyanate to the total equivalent of the polyol intermediate and the chain extender is thus from about 0.95 to about 1.10, or from about 0.96 to about 1.02 and even from about 0.97 to about 1.05. The chain extension reaction temperature is generally from about 180 to about 250° C. or from about 200 to about 240° C. Typically, the pre-polymer route can be carried out in any conventional device including an extruder. In such embodiments, the polyol intermediates are reacted with an equivalent excess of a diisocyanate in a first portion of the extruder to form a pre-polymer solution and subsequently the chain extender is added at a downstream portion and reacted with the pre-polymer solution. Any conventional extruder can be utilized, including extruders equipped with barrier screws having a length to diameter ratio of at least 20 and in some embodiments at least 25.

In one embodiment, the ingredients are mixed on a single or twin screw extruder with multiple heat zones and multiple feed ports between its feed end and its die end. The ingredients may be added at one or more of the feed ports and the resulting TPU composition that exits the die end of the extruder may be pelletized.

The preparation of the various polyurethanes in accordance with conventional procedures and methods and since as noted above, generally any type of polyurethane can be utilized, the various amounts of specific components thereof, the various reactant ratios, processing temperatures, catalysts in the amount thereof, polymerizing equipment such as the various types of extruders, and the like, are all generally conventional, and well as known to the art and to the literature.

For the present invention, in some embodiments the TPU may be made by reacting the components together in a “one shot” polymerization process wherein all of the components, including reactants are added together simultaneously or substantially simultaneously to a heated extruder and reacted to form the TPU. In other embodiments, the TPU may be made by first reacting the polyisocyanate component with some portion of the polyol component forming a pre-polymer, and then completing the reaction by reacting the pre-polymer with the remaining reactants, resulting in the TPU.

One or more polymerization catalysts may be present during the polymerization reaction. Generally, any conventional catalyst can be utilized to react the diisocyanate with the polyol intermediates or the chain extender. Examples of suitable catalysts which in particular accelerate the reaction between the NCO groups of the diisocyanates and the hydroxy groups of the polyols and chain extenders are the conventional tertiary amines known from the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane and the like, and also in particular organometallic compounds, such as titanic esters, iron compounds, e.g. ferric acetylacetonate, tin compounds, e.g. stannous diacetate, stannous dioctoate, stannous dilaurate, or the dialkyltin salts of aliphatic carboxylic acids, e.g. dibutyltin diacetate, dibutyltin dilaurate, and the like, or bismuth compounds such as bismuth octoate, bismuth laurate, and the like. The amounts usually used of the catalysts are from 0.0001 to 0.1 part by weight per 100 parts by weight of polyhydroxy compound (b).

In one embodiment, the TPU compositions used in the multi-layer, flexible fuel tubes of the present invention have a flex modulus measured according to ASTM D790 of 50,000 psi or less.

In one embodiment of the invention, the TPU compositions comprise the reaction product of a diisocyanate component, a polyol intermediate component, and, optionally, a chain extender component, wherein the polyol intermediate component constitutes at least 25% by weight of the reaction mixture, or constitutes more than 25% by weight of the reaction mixture.

### Ethylene Vinyl Alcohol

Ethylene vinyl alcohols (“EVOH”) are generally made by copolymerizing about 20 to 60 mole percent, for example, about 25 to 50 mole percent ethylene with about 40 to 80 mole percent, for example, 50 to 75 mole percent vinyl acetate followed by hydrolysis or alcoholysis. EVOH derived from copolymers of greater than about 80 mole percent vinyl acetate tend to be difficult to extrude, while those having less than about 40 mole percent vinyl acetate generally do not provide good barrier properties.

The ethylene/vinyl acetate copolymer may be hydrolyzed or alcoholized in the present of a catalyst, such as sodium methoxide or sodium hydroxide, until the desired amount of conversion (saponification) to ethylene vinyl alcohol polymer is achieved.

EVOH may also include optional comonomers, such as, propylene, butene-1, pentene-1, or 4-methylpentene-1 in such small amounts as to not change the inherent properties of the copolymer—generally up to about 5 mole % based on the total copolymer. The EVOH melting point is preferably in the range of about 150° C. and 190° C. The EVOH melt flow index will generally be about 0.5 to 30 g/10 min. at 210° C. using a 2160 g weight.

### Polyamide Polymer

The polyamide polymers useful in the present invention are also commonly referred to as nylon. These polymers are generally any long-chain synthetic polymeric amides or superpolyamides, which have recurring amide groups as an integral part of the main polymer chain. Essentially, these polyamides are of two types, those which are made from diamines and diacids, and those which are made by the self-condensation of omega-amino acids such as omega-amino undecanoic acid. Normal nylon is made from hexam thylene diamine and adipic acid and may be used in accordance with the present invention. A similar polyamide is made from hexamethylene diamine and sebacic acid. Still another polyamide is made from eta-caprolactam which reacts by self-condensation mechanism as if it were eta-amino caproic acid.

Polyamides useful in the present invention include those known as nylon 6 (polycaprolactam), nylon 11 (polyundecanolactam), and/or nylon 12 (polydodecanolactam).

As mentioned above, the present invention provides a multi-layer, flexible tubular article useful for transporting volatile hydrocarbon fuels comprising (a) a thermoplastic polyurethane layer, (b) an ethylene vinyl alcohol layer, and optionally, (c) an polyamide polymer layer. In another embodiment, the present invention provides a multi-layer, flexible tubular article useful for transporting volatile hydrocarbon fuels comprising (a) a thermoplastic polyurethane layer, (b) an ethylene vinyl alcohol layer, and (c) a polyamide polymer layer.

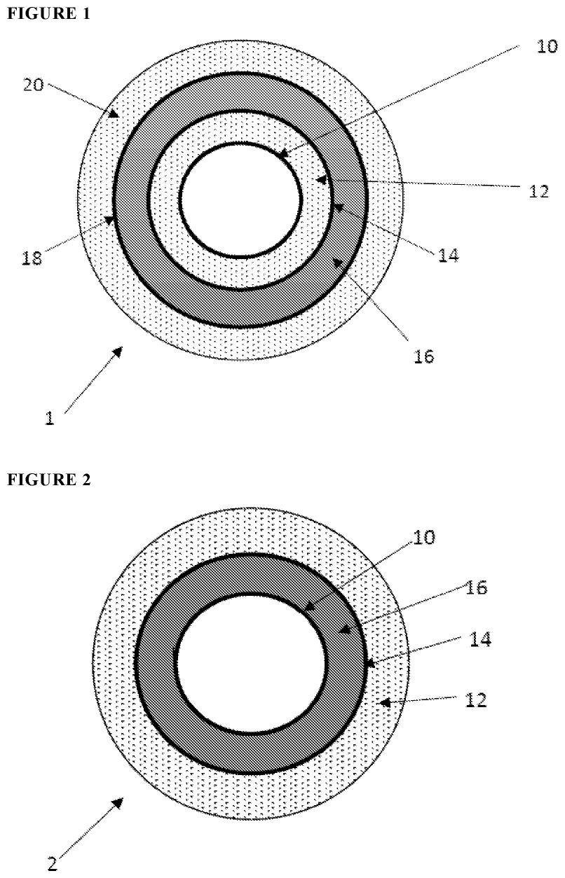

Turning now to the figures, exemplary constructions of the multi-layer, flexible tubular article are shown. In both FIGS. 1 and 2, multi-layer tubublar articles (1, 2) are illustrated. In both embodiments, the multi-layer tubular articles comprise a first TPU layer 10, which is the inner (direct fuel contact) layer of the tube. The embodiment of FIG. 1 includes a polyamide (nylon) layer 12 as the second layer directly adjacent to the TPU layer 10. The next layer in embodiment 1 is a second TPU layer 14, followed by a layer of EVOH 16. Another layer of TPU 18 and polyamide (nylon) 20 are included over the EVOH layer. It should be noted that all of these layers are adhered together by the TPU layers 10, 15, and 18 without the use of a separate adhesive or tie layer. The embodiment of FIG. 2 illustrates a different arrangement of the layers. In this embodiment, the layer of EVOH 16 is positioned directly adjacent to the first TPU layer 10, followed by a second TPU layer 14, and a polyamide (nylon) layer 12.

The article of the present invention may be made by any methods known to those skilled in the art. In one embodiment, the thermoplastic polyurethane layer, the EVOH layer, the polyamide layer, and the one or more additional intermediate thermoplastic polyurethane layers between layers of polyamide and EVOH are co-extruded. Co-extrusion processes are known in the art. For example, co-extrusion equipment and processes are described in U.S. Pat. Nos. 4,182,603 and 5,641,445.

It should be noted that the invention is not limited to the exemplary constructions shown in the figures. Any configurations of TPU, EVOH, and optionally, polyamide (nylon) may be used depending on the end use application. In one embodiment, the TPU layer is the inner (fuel contact) layer in order to avoid undesired washout or leaching of chemicals from the fuel tube into the fuel.

In any of the embodiments described above, the thermoplastic polyurethane layer comprises the reaction product of a polyisocyanate component, a polyol intermediate component, and, optionally, a chain extender component. In one embodiment, the polyol intermediate comprises a polyether polyol, for example, PTMEG. In another embodiment, the polyol intermediate comprises a polyester polyol, for example the reaction product of butane diol and sebacic acid (butane diol sebacate). In another embodiment, the polyol intermediate comprises polycaprolactone polyol. In an embodiment with multiple TPU layers, each layer may be the same or different, depending on the requirements of the specific application or use of the tube. For example, in one embodiment, the inner TPU layer (e.g. 10 in FIGS. 1 and 2) may comprise a polyester polyol, such as butane diol sebacate, while one or more of the outer TPU layers (e.g. 14 and 18 in FIGS. 1 and 2) may comprise a polyether or polycaprolactone polyol.

In addition, in any of the embodiments of the multi-layer, flexible tubular articles mentioned above, the TPU layer or layers may have a flex modulus as measured by ASTM D790 of 50,000 psi or less.

Further, in addition, in any of the embodiments of the multi-layer, flexible tubular articles mentioned above, the TPU composition may comprise 25% or more by weight of the polyol intermediate component. This level of polyol in the TPU composition is believed to provide the flexibility needed for fuel line applications.

In addition, in one embodiment of the present invention, the multi-layer, flexible tubular articles are free of or substantially free of fluoropolymers.

The multi-layer, flexible tubular articles of the present invention are particularly suitable for use in fuel line applications, including liquid and vapor fuel line applications. The multi-layer, flexible tubular article may also be used in fuel containment systems. In particular, the tubes may be used in an automotive system, which comprises an engine and a fuel line, wherein the fuel line comprises the multi-layer, tubular article as described herein.

In consideration of the potential applications for the multi-layer, flexible tubular articles, the present invention also includes a method for reducing chemical washout from fuel tubes. The method includes providing a multi-layer, flexible tubular article comprising (a) an inner layer of a thermoplastic polyurethane, (b) at least one polyamide polymer layer, and (c) at least one EVOH layer, wherein the at least one polyamide polymer layer and the at least one EVOH layer are extruded over the inner layer. The multi-layer tube may also comprise one or more additional thermoplastic polyurethane layers in between the polyamide and EVOH layers. In one embodiment of this method, the inner layer of the multi-layer tubular article comprises a thermoplastic polyurethane material wherein the thermoplastic polyurethane material consists of the reaction product of (1) a diisocyanate component, (ii) at least 25% by weight of a polyol intermediate component, and, optionally, (iii) a chain extender component, wherein the thermoplastic polyurethane has a flexural modulus of 50,000 psi or less as measured by ASTM D790. In this method, the polyol intermediate may be a polyester polyol comprising the reaction product of butane diol and sebacic acid.

The present invention also includes the use of a flexible, multi-layer tubular article comprising (a) an inner layer, wherein the inner layer comprises a thermoplastic polyurethane material wherein the thermoplastic polyurethane material consists of the reaction product of (1) a diisocyanate component, (ii) a polyol component, and, optionally, (iii) a chain extender diol and (b) an outer layer, wherein the outer layer comprises a polyamide polymer layer and/or an EVOH layer in order to reduce chemical washout in volatile hydrocarbon based fuels in engines. In one embodiment, the multi-layer tube includes both a polyamide polymer layer and an EVOH layer with intermediate thermoplastic polyurethane layers in between. Thermoplastic polyurethane compositions used in the multi-layer structure may have a flexural modulus of 50,000 psi or less as measured by ASTM D790. In one embodiment, the polyol component comprises a polyester polyol which is the reaction product of butane diol and sebacic acid.

All molecular weight values provided herein are weight average molecular weights unless otherwise noted. All molecular weight values have been determined by GPC analysis unless otherwise noted.

As used herein, the transitional term “comprising”, which is synonymous with “including”, “containing”, or “characterized by”, is inclusive or open-ended and does not exclude additional, un recited elements or method steps. However, in each recitation of “comprising” herein, it is intended that the term also encompass, as alternative embodiments, the phrases “consisting essentially of” and “consisting of”, where “consisting of” excludes any element or step not specified and “consisting essentially of” permits the inclusion of additional un recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A multi-layer, flexible, tubular article for transport of volatile hydrocarbon fuel comprising:
(a) a thermoplastic polyurethane layer;
(b) an ethylene vinyl alcohol layer; and
(c) optionally, a polyamide polymer layer; and.

2. The article of claim 1 wherein the thermoplastic polyurethane has a flexural modulus of 50,000 psi or less measured by ASTM D790.

3. The article of claim 1 wherein the thermoplastic polyurethane comprises product of (i) a diisocyanate component, (ii) at least 25% by weight of a polyol component, and, optionally, (iii) a chain extender diol.

4. The article of claim 1 wherein the polyol component comprises a polyester polyol which comprises the reaction product of butane diol and sebacic acid.

5. The article of claim 1 wherein the polyol component comprises any one of a polyether polyol, a polycaprolactone polyol, or a polysiloxane polyol.

6. The article of claim 1 wherein an inner layer of the multi-layer, flexible, tubular article is the thermoplastic polyurethane layer.

7. The article of claim 1 wherein the article is substantially free of fluoropolymers.

8. The article of claim 1 which comprises a polyamide polymer layer.

9. The article of any of claim 8 comprising one or more additional thermoplastic polyurethane layers positioned between the polyamide polymer layer and the ethylene vinyl alcohol layer.

10. The article of claim 8, wherein the thermoplastic polyurethane layer, the ethylene vinyl alcohol layer, the polyamide layer, and the one or more additional thermoplastic polyurethane layers are co-extruded.

11. An automobile comprising a fuel line, wherein the fuel line comprises the multi-layer, flexible tubular article of claim 1.

12. A multi-layer, flexible tubular article for transport of volatile hydrocarbon fuel comprising:
(a) an inner layer, wherein the inner layer comprises a thermoplastic polyurethane material wherein the thermoplastic polyurethane material consists of the reaction product of (1) a diisocyanate component, (ii) a polyol intermediate component, and, optionally, (iii) a chain extender component, wherein the thermoplastic polyurethane has a flexural modulus of 50,000 psi or less as measured by ASTM D790; and
(b) at least one polyamide polymer layer;
(c) at least one ethylene vinyl alcohol layer; and
(d) optionally, at least one additional thermoplastic polyurethane layer positioned between the polyamide polymer layer and the ethylene vinyl alcohol layer.

13. The article of claim 12, wherein the polyol intermediate component comprises a polyester polyol comprising the reaction product of butane diol and sebacic acid.

14. The article of claim 12, wherein the polyol intermediate component comprises a polyether polyol.

15. The article of claim 12, wherein the polyol intermediate component comprises a polycaprolactone polyol.

16. The article of claim 12, wherein the inner layer and the additional thermoplastic polyurethane layer are made from different thermoplastic polyurethane compositions.

17. The article of claim 12, wherein the inner layer and the additional thermoplastic polyurethane layer are made from the same thermoplastic polyurethane composition.

18. A method for reducing chemical washout from fuel tubes comprising the steps of:
providing a multi-layer, flexible tubular article comprising (a) an inner layer of a thermoplastic polyurethane, (b) at least one polyamide polymer layer, and (c) at least one ethylene vinyl alcohol layer, wherein the at least one polyamide polymer layer and the at least one ethylene vinyl alcohol layer are extruded over the inner layer.

19. The method of claim 18 wherein the inner layer comprises a thermoplastic polyurethane material wherein the thermoplastic polyurethane material consists of the reaction product of (1) a diisocyanate component, (ii) at least 25% by weight of a polyol intermediate component, and, optionally, (iii) a chain extender component, wherein the thermoplastic polyurethane has a flexural modulus of 50,000 psi or less as measured by ASTM D790.

20. The use of a flexible, multi-layer tubular article comprising (a) an inner layer, wherein the inner layer comprises a thermoplastic polyurethane material wherein the thermoplastic polyurethane material consists of the reaction product of (1) a diisocyanate component, (ii) a polyester polyol comprising the reaction product of butane diol and sebacic acid, and (iii) a chain extender diol, wherein the thermoplastic polyurethane has a flexural modulus of 50,000 psi or less as measured by ASTM D790 and (b) an outer layer, wherein the outer layer comprises a polyamide polymer layer and/or an ethylene vinyl alcohol layer in order to reduce chemical washout in volatile hydrocarbon based fuels in engines.
